(19) United States
(12) Patent Application Publication
(10) Pub. No.: US 2017/0156442 A1
(43) Pub. Date: Jun. 8, 2017

(54) METHOD FOR PROVIDING PARTS OF WATERPROOF AND BREATHABLE SHOES, PARTS OF WATERPROOF AND BREATHABLE SHOES PROVIDED WITH THE METHOD, AND WATERPROOF AND BREATHABLE SOLES PROVIDED WITH THE SHOE PARTS

(71) Applicant: GEOX S.p.A., Montebelluna (IT)

(72) Inventor: Mario POLEGATO MORETTI, Crocetta Del Montello (IT)

(73) Assignee: GEOX S.p.A., Montebelluna (IT)

(21) Appl. No.: 15/325,228

(22) PCT Filed: Jul. 10, 2015
(86) PCT No.: PCT/EP2015/065876

§ 371 Date: Jan. 10, 2017

(30) Foreign Application Priority Data
Jul. 11, 2014 (IT) PD2014A000184

(51) Int. Cl. A43B 23/02; B29D 35/00; B29C 45/17; A43B 13/22; A43B 13/12; A43B 3/00; A43B 13/04; B29D 35/12; B29C 45/14

(52) U.S. Cl. CPC A43B 23/022; B29D 35/122; B29D 35/0009; B29C 45/1753; B29D 35/0018; B29D 35/128; B29C 45/14336; A43B 13/122; A43B 3/0078; A43B 13/04; A43B 13/223; A43B 23/026; B29L 2031/504

(57) ABSTRACT

A method for providing parts of waterproof and breathable shoes, parts of waterproof and breathable shoes provided with the method, and waterproof and breathable soles provided with the shoe parts. The method uses a mold including a first element and a second element, at least one of which has hollow regions of a matrix of impressions, which are filled with polymeric material in the fluid state by depositing it in the hollow regions or by injecting it while the mold is closed; a support made of flexible sheet is interposed between the first element and the second element and includes a waterproof and breathable functional element, on which, when the mold is closed, the polymeric material sets and adheres to the support.

The present invention relates to a method for providing parts of waterproof and breathable shoes, to parts of waterproof and breathable shoes provided with said method, and to waterproof and breathable soles provided with said shoe parts.

As is known, during use of a shoe humidity caused by perspiration of the foot can accumulate inside such shoe, particularly at the interface between the sole of the foot and the sole of the shoe. The sweat generated at the sole of the foot saturates with humidity the air inside the shoe and mostly condenses, stagnating on the plantar insert.

The stagnation of sweat in the plantar region is an effect that occurs particularly in shoes with a sole made of rubber, which as is known is a fully impermeable material and therefore prevents vapor permeation.

Therefore, the need is particularly felt to render the shoe able to ensure correct exchange of heat and water vapor between the microclimate inside the shoe and the external microclimate, in order to obviate therefore also the stagnation of humidity.

This requirement must be met, however, without compromising the impermeableness of the shoe to external humidity or to water.

In this regard, a first possible solution was devised in Italian patent no. 1232798, the teaching of which consists in dividing the rubber sole into two layers, of which the lowest has through microperforations, and in interposing therein a semipermeable membrane that is joined perimetrically to the two layers in order to avoid water infiltrations. In this manner a rubber sole is obtained that is impermeable to water in the liquid state and permeable to water vapor.

An element with these properties of permeability to water vapor and impermeable to water in a liquid state is hereinafter referenced as a waterproof and breathable.

In applying this solution, some drawbacks arise for shoes that have a thin rubber sole. For these shoes it is in fact difficult to divide the sole into two parts, which otherwise would have an insubstantial thickness.

Usually, these membranes are currently used in the fields of clothing and footwear, the market of which requires soft and comfortable items, where the membrane, understood as a functional layer, must not compromise these characteristics.

The use of membranes, for example of the type disclosed in patents by W. L. Gore or by BHA Technologies, is taught. These membranes are made of thin films of expanded polytetrafluoroethylene (e-PTFE), with thicknesses that vary usually from 19 to 70 microns, are waterproof and breathable, in order to be laminated with backing and/or aesthetic finishing materials, such as fabric or leather, so as to obtain laminated products that have characteristics such as flexibility and easy bending, ensuring at the same time impermeableness to water and permeability to water vapor.

However, indeed due to their low thickness, these membranes have limited mechanical strength characteristics.

In particular, membranes with a thickness comprised in the above cited range have a penetration resistance of less than 5 N, where penetration resistance is understood as the characteristic defined by a measurement performed according to the method described in ISO standard 20344-2004, in chapter 5.8.2, “Determination of the penetration resistance of the sole”, related to safety shoes.

In the shoemaking sector, the problem of limited mechanical strength in fact becomes manifest in the penetration of foreign objects that make contact with the membrane, entering through the holes of the sole, which the membrane faces.

In order to solve this problem, the same inventor proposes to limit the width of the holes of the lower layer of the sole. However, this entails a reduction of the area of the sole assigned to vapor permeation and a higher possibility that the holes might be blocked.

A solution aimed at overcoming these drawbacks is the one proposed with the teaching contained in Italian patent no. 1282196, by the same applicant. This patent proposes the use of a sole made of elastomer that is provided with through holes and comprises a mid-sole that is composed of a membrane that is impermeable to water and breathable for water vapor and is superimposed on a lower protective layer, preferably made of felt, treated so as to be water-repellent.

Since this layer is not waterproof, it is not possible to seal the mid-sole directly to the sole, but a waterproof perimetric element is used for this purpose which provides a sealing bridge between the waterproof and breathable membrane and the sole.

However, the use of a laminate and of a perimetric seal, which joins the membrane to the sole, reduces considerably the overall flexibility of the sole, since both occupy also the region of the shoe that is subject to bending.

Furthermore, the area of the membrane is usually limited to the front region of the sole and is narrower than the contour thereof in order to allow the gluing of the upper to the sole at its edges.

Moreover, in order to ensure effective protection of the membrane, the connection thereof with the protective layer must occur by intimate adhesion thereof. For this purpose, adhesives and glues are applied between the two and limit the breathable portion. Furthermore, the protective layer, though being breathable, also constitutes in itself a hindrance to the passage of the water vapor, in addition to the fact that its breathability characteristic tends to decrease progressively when, due to aging caused by use of the shoe, it reduces its water-repellency characteristics and therefore tends to become impregnated with water and mud, which reach it through the holes of the tread.

This last drawback, therefore, limits the protection of the membrane, which by being in contact with the felt impregnated with water and substances of the ground is subject in the long term to early aging.

In the case of thin soles, moreover, it is not possible to provide a receptacle for the membrane and the protective layer within the thickness of the sole, since otherwise the tread would not be thick enough to resist wear and therefore it is necessary to apply the membrane above the surface of the sole. During assembly, therefore, since the thicknesses are not leveled, they might lead to deform the touching ground point of the sole.

Not least drawback affecting both of the above cited solutions is due to the fact that the continual flexing and traction to which the shoe, and therefore the sole, is subjected during walking can cause progressive wear and tearing of the membrane, causing loss of waterproofness of the sole.

Soles have also been devised which have holes that are small, in order to contrast the perforation of the membrane, and are sufficiently spaced, in order to avoid tearing of the regions comprised between one hole and the next; on the other hand, however, the sole area that is actually breathable is limited.

A good compromise was found to be achievable with the solution proposed in Italian patent no. 1334928 by the same applicant. Such patent discloses a sole that has a supporting layer which, at least in one macroportion, is made of mesh, felt or other diffusely perforated material and with which a membrane is associated in an upper region, at least at the macroportion, the membrane being permeable to water and impermeable to water vapor, reinforced with protective layers and tearing-resistant layers, made for example of Nylon or Kevlar fabric.

Furthermore, a sole made of polymeric material, with at least one through macrohole at the macroportion, is joined hermetically to the membrane and to the supporting layer, at the perimeter of the macroportion.

The macrohole defines for the membrane a large surface for exchange with the outside of the shoe and the loss of structural rigidity of the sole is compensated by the supporting layer, which protects the membrane against tearing.

However, the passage of vapor is reduced by the presence of the various layers that compose the supporting layer.

The aim of the present invention is to devise a method for providing parts of waterproof and breathable shoes that allow to obviate the drawbacks described above.

Within this aim, an object of the invention is to devise a method that allows to obtain with reduced manufacturing times waterproof and breathable shoe parts that bear elements made of polymeric material having abrasion resistance characteristics.

Another object of the invention is to provide waterproof and breathable shoe parts that are capable of dissipating larger quantities of water vapor than currently known ones.

Another object of the invention is to produce waterproof and breathable shoe parts that allow to provide shoes that have waterproof, breathable and tough soles.

Another object of the invention is to provide waterproof and breathable soles that are capable of stopping the water outside the sole, thus preventing it from remaining trapped within holes or openings to be provided in the tread.

Another object of the invention is to devise a method that can be performed with low costs and uses known technologies.

This aim, as well as these and other objects that will become better apparent hereinafter, are achieved by a method for providing parts of waterproof and breathable shoes, which consists in:
preparing a mold of the type comprising a first element to be closed with a second element, at least one of which has hollow regions of a matrix of impressions and the remaining surface for mating with the other one of said elements;
opening said mold,
depositing in said hollow regions polymeric material in the fluid state with abrasion resistance characteristics,
cleaning said mating surface from any excess polymeric material by cleaning means,
positioning on at least one said mating surface a support made of flexible sheet comprising a waterproof and breathable functional element,
closing said mold with the interposition of said support made of flexible sheet between said first element and said second element,
opening said mold after a time interval at least equal to the setting time of said polymeric material with adhesion to said support.

Furthermore, the present invention relates to a method for providing parts of waterproof and breathable shoes, which consists in:
preparing a mold of the type comprising a first element and a second element, which substantially constitute respectively a first mold part and a second mold part and at least one of said elements having hollow regions of a matrix of impressions fed by an injector,
opening said mold,
placing on a mating surface of said first element and said second element a support made of flexible sheet, which comprises a waterproof and breathable functional element,
closing said mold with the interposition of said support made of flexible sheet between said first element and said second element,
injecting a polymeric material in the fluid state with abrasion resistance characteristics in said matrix of impressions by means of said injector,
opening said mold after a time interval equal at least to the setting time of said polymeric material with adhesion to said support.

Moreover, the present invention relates to a part of a waterproof and breathable shoe provided by means of one of the above cited methods, characterized in that it comprises said support made of flexible sheet on the surface of which at least one element made of polymeric material with abrasion resistance characteristics is molded.

Further characteristics and advantages of the invention will become better apparent from the description of two preferred but not exclusive embodiments of the method according to the invention, illustrated by way of nonlimiting example in the accompanying drawings, wherein:

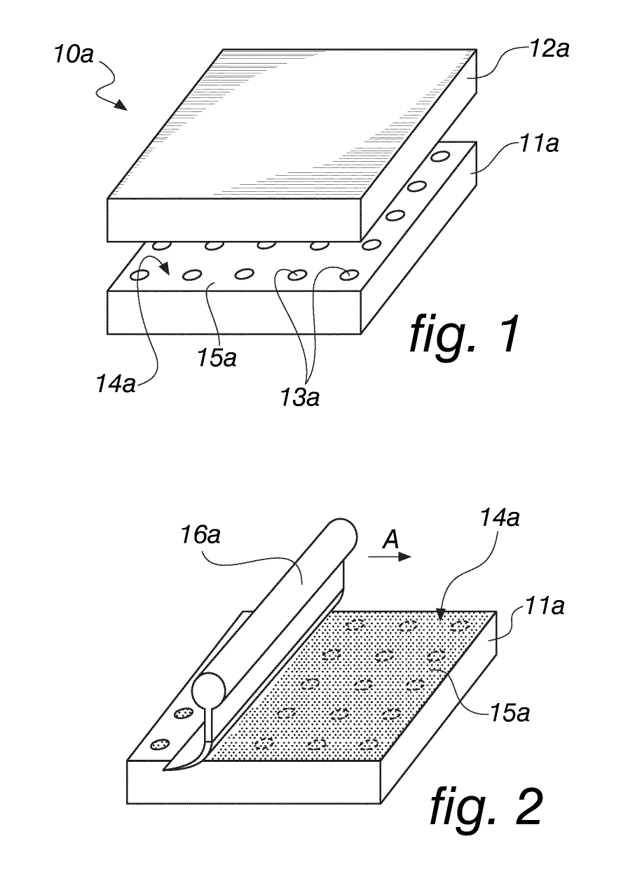

FIG. 1 is a schematic view of the mold to be used in the first embodiment of a method according to the invention;

FIG. 2 is a view of the cleaning of the mating surface of the first element;

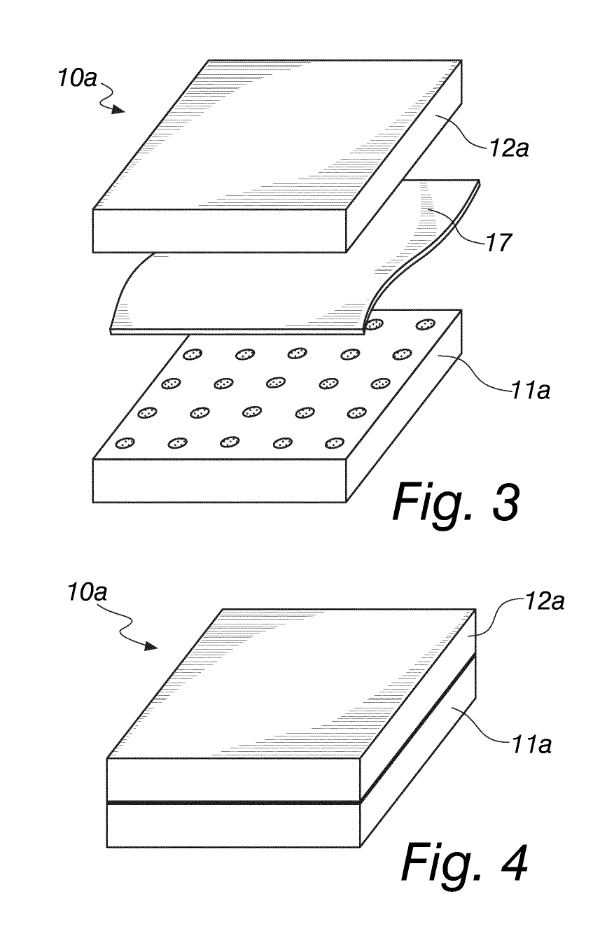

FIG. 3 is a view of the closure of the mold with the interposition of the support made of flexible sheet;

FIG. 4 is a view of the step of setting, with the mold closed, on the support made of flexible sheet;

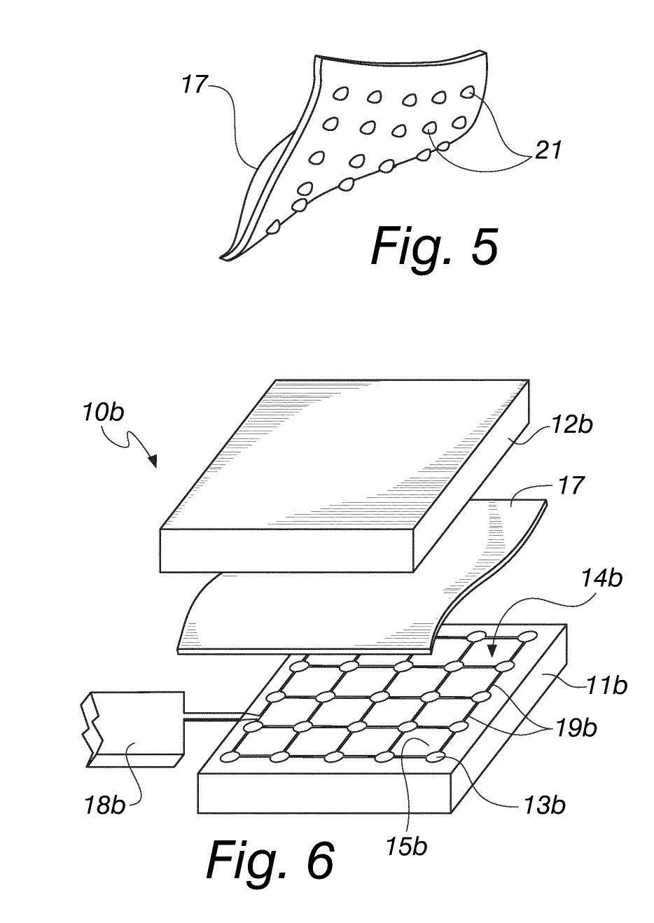

FIG. 5 is a view of the support made of flexible sheet obtained by means of the first embodiment of the method according to the invention;

FIG. 6 is a view of the closure of the mold to be used in the second embodiment of the method according to the invention, with the interposition of the support made of flexible sheet;

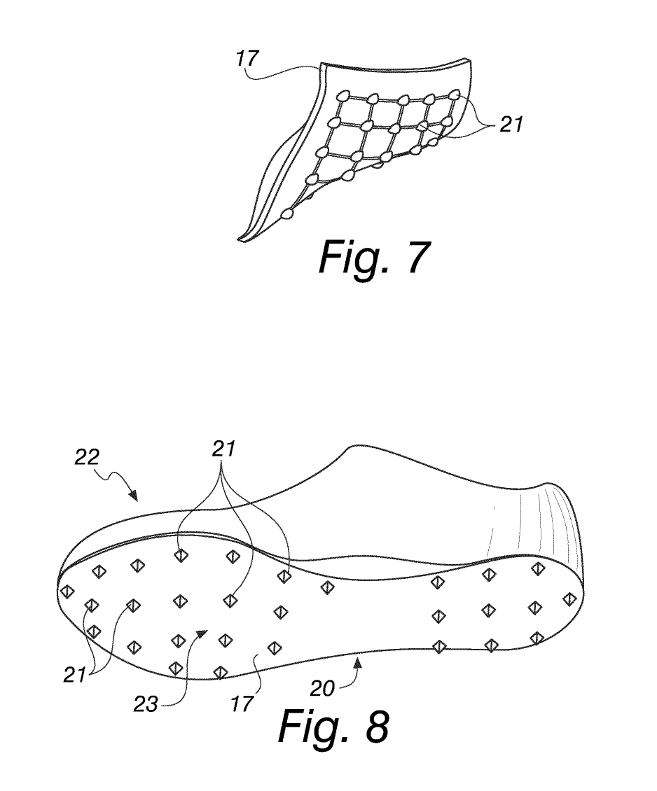

FIG. 7 is a view of the support made of flexible sheet obtained by means of the method according to FIG. 6;

FIG. 8 is a view of a shoe provided with a shoe part according to the invention;

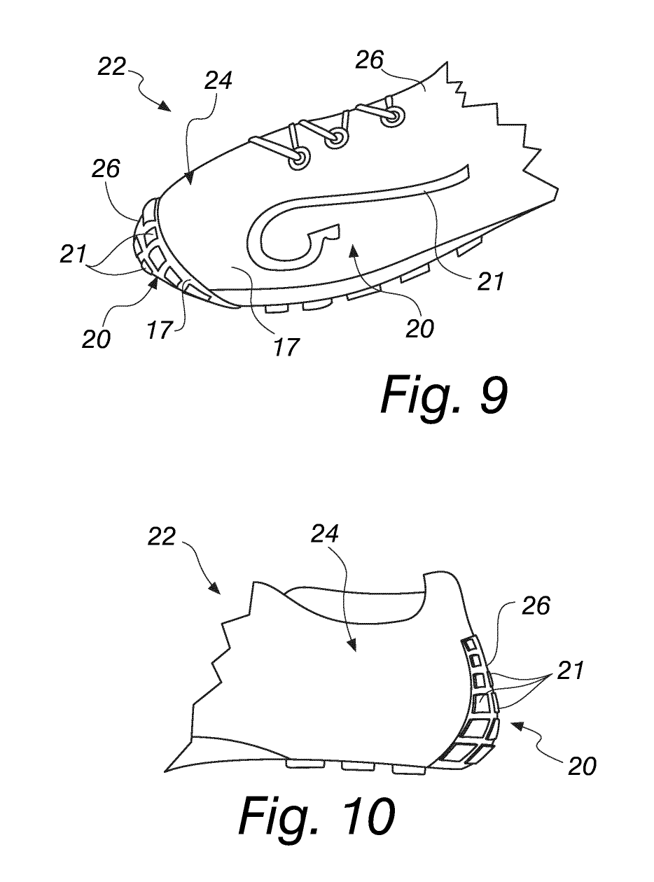

FIG. 9 is a view of a shoe portion provided with two examples of shoe parts according to the invention;

FIG. 10 is a view of another shoe portion that supports another example of a shoe part according to the invention;

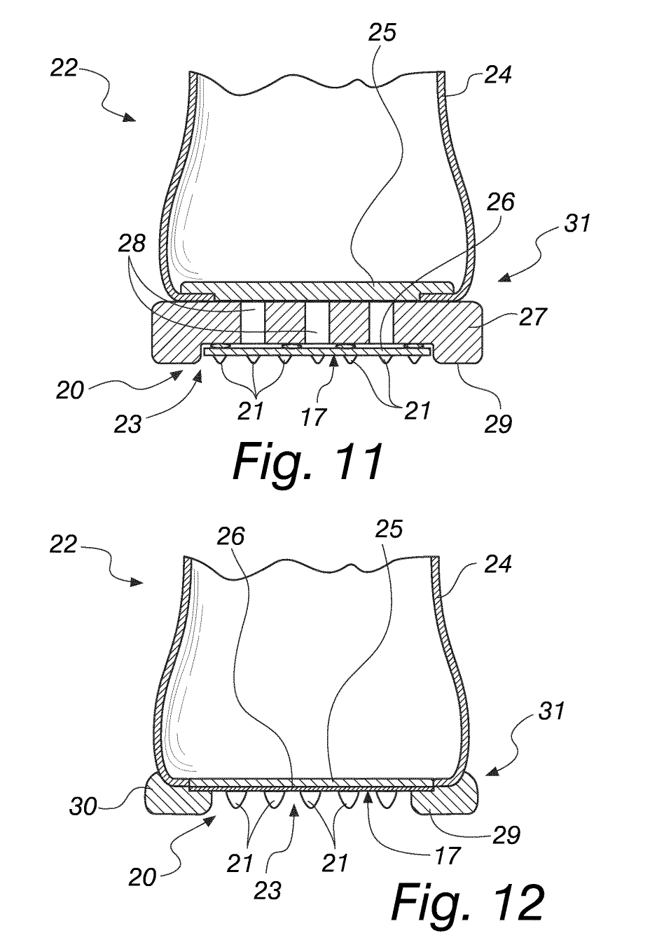

FIG. 11 is a sectional view of a shoe with a shoe part according to the invention;

FIG. 12 is a sectional view of another shoe;

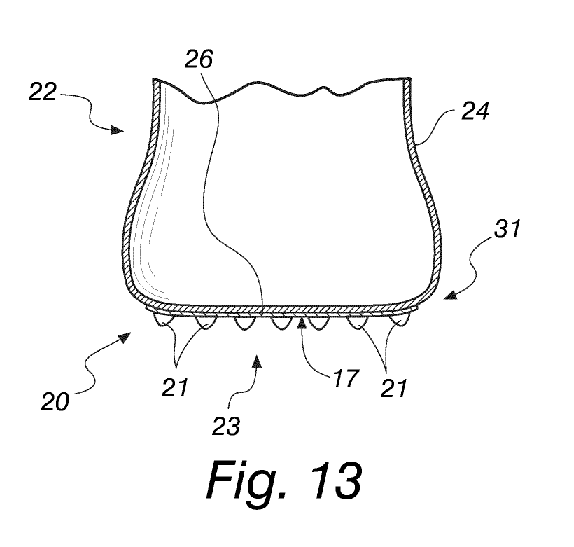

FIG. 13 is a sectional view of a further shoe.

It is noted that anything found to be already known during the patenting process is understood not to be claimed and to be the subject of a disclaimer.

With reference to the figures, the method according to the invention consists of the steps listed hereinafter.

The method comprises preparing a mold 10a of the type shown in FIG. 1, i.e., the type that comprises a first element 11a, which is lower with respect to the figure that illustrates it, to be closed with a second element 12a, which is upper with respect to the same figure, one of which, the first element 11a in the illustrated example, is provided with hollow regions 13a of a matrix of impressions 14a and the remaining surface 15a for mating with the second element 12a.

In other constructive variations, the first element 11a and the second element 12a can constitute respectively a first mold part and a second mold part, at least one of the two having the hollow regions 30a of the matrix of impressions 14a or, while the first element 11a can constitute a first mold part, the second element 12a can constitute a plate of a press, with heated plates for the setting of the polymeric material.

The method then consists in opening the mold 10a and in depositing in the hollow regions 13a of the first element 11a a polymeric material in the fluid state with abrasion resistance characteristics, until they are filled completely.

In a possible variation, the element provided with the hollow regions 13a can be the second element 12a, or in any case the one to be turned over onto the other, thanks to the fact that the setting reaction is triggered immediately and causes the fluid material to set partially, so as to adhere to the element to be turned over for the time sufficient for the mold closure operation.

The polymeric material with abrasion resistance characteristics is selected among compact high-density polyurethane (PU), expanded polyurethane, polyvinyl chloride (PVC), and other similar ones.

Conveniently, the first element 11a, with the hollow regions 13a filled with polymeric material in the fluid state, is then introduced in a vacuum chamber, where it is brought to a vacuum pressure of approximately 0.5 mbars, so as to eliminate any bubbles produced in the fluid as a consequence of the deposition of the polymeric material and of the beginning of the setting reaction.

The mating surface 15a is then cleaned of any excess polymeric material, which therefore may have dirtied said surface or which is in excess with respect to the volume of the hollow regions 13a or also covers completely the surface as shown in FIG. 2, by means of adapted cleaning means 16a, preferably a doctor or a spatula.

In FIG. 2, the letter A designates the direction of motion of the doctor with respect to the first element 11a and it is clearly visible that to the left of the doctor, where it has already passed, the mating surface 15a is clean and only the hollow regions 13a are filled with the polymeric material.

A support 17 made of flexible sheet is then positioned on the mating surface 15a of the first element 11a and comprises a waterproof and breathable functional element 26 and the mold 10a is closed with the interposition thereof between the first element 11a and the second element 12a, as shown in the two subsequent steps of FIG. 3 and FIG. 4.

The mold 10a is introduced in an oven and brought to a temperature of approximately 60° in order to facilitate the setting reaction of the polymeric material.

The mold 10a is then opened after a time interval equal at least to the setting time of the polymeric material with adhesion to the support 17 (which is, by way of example, approximately 20-25 minutes).

An example of support 17 made of flexible sheet obtained by means of the method described above is shown in FIG. 5.

In a second alternative embodiment, the method consists of the following steps.

The method comprises preparing a mold, designated here by the reference numeral 10b in FIG. 6, of the type that comprises a first element 11b, which is lower with respect to the figure that illustrates it, and a second element 12b, which is upper with respect to the same figure, constituting respectively a first mold part and a second mold part and at least one of them being provided with hollow regions of a matrix of impressions 14b that are fed by an injector 18b. In the illustrated case, between said two elements only the first one 11b carries the matrix of impressions 14b and is fed by the injector 18b.

In particular, as clearly visible in FIG. 6, the hollow regions 13b of the matrix of impressions 14b are mutually connected by means of injection channels 19b.

As an alternative, in another version of the mold each hollow region 13b of the matrix of impressions 14b can be fed by an injection channel.

In succession, the mold 10b is opened and a support 17 made of flexible sheet, comprising a waterproof and breathable functional element 26, is positioned on a mating surface 15b of one of the two elements, the first one 11b or the second one 12b.

The mold 10b is then closed with the interposition of the support 17 made of flexible sheet between the first element 11b and the second element 12b and then a polymeric material is injected in the fluid state in the matrix of impressions 14b by means of the injector 18b, until the volumes of the hollow regions 13b are completely filled with said material.

In particular, said thermoplastic material with abrasion resistance characteristics is selected among thermoplastic polyurethane (TPU), thermoplastic rubber (TR), and the like.

Finally, after a time interval that is at least equal to the setting time of the polymeric material, with adhesion to the support 17 (which is approximately 5-10 minutes), the mold 10b is opened. At the end of the method the extracted support 17 has the appearance shown in FIG. 7.

By means of both of the methods it is possible to provide waterproof and breathable shoe parts 20, which will be described in greater detail hereinafter, comprising a support 17 of the type made of flexible sheet that comprises a waterproof and breathable functional element 26 and on the surface of which at least one element 21 made of polymeric material with abrasion resistance characteristics is molded.

In particular, as shown in FIGS. 5 and 7, the support 17 has a plurality of said elements 21 distributed on the surface and its application to a generic shoe 22 is proposed in FIG. 8 for a shoe part 20, the sole in this example, so as to cover at least some portions thereof.

Preferably, the polymeric material of the elements 21 covers substantially 10% of the surface of the support 17. As an alternative, it can cover a percentage thereof comprised substantially between 10% and 20% or substantially between 10% and 30%.

The elements 21 distributed on the support 17 constitute the tread 23 of the shoe 22.

Some examples of shoe parts 20 are shown in FIG. 9 and in FIG. 10.

FIG. 9 shows the front portion of the shoe 22, which shows that the shoe part 20, a toe cap associated with the upper 24 in order to reinforce its tip, is provided by way of one of the described methods. It in fact comprises a support 17 which comprises a waterproof and breathable functional element 26, which substantially constitutes a portion of the upper 24 of the shoe 22, on which some elements 21 are molded so as to constitute a reinforcement part.

FIG. 10 shows an example similar to the preceding one, in which the shoe part 20 constitutes another portion of the upper 24 on which elements 21 are molded so as to constitute another reinforcement part of the shoe, in this case a rear counter.

FIG. 9 also shows a further shoe part 20. In this case, the support 17 constitutes a portion of the upper 24, on one side of the shoe 22, on which an element 21 is molded so as to constitute a decorative element for the shoe 22.

From what has been described so far, it is intuitive that the support 17 made of flexible sheet lends itself to being used both to provide soles and parts thereof and to provide uppers 24 and parts thereof.

It can be constituted by a different number of layers or by a single layer.

With the goal of ensuring correct exchange of heat and water vapor between the microclimate inside the shoe and the external microclimate, a support 17 made of flexible sheet lends itself to be subjected to the described methods and comprises a waterproof and breathable functional element 26, constituted preferably by polymeric material that is impermeable to water in the liquid state and permeable to water vapor.

Such functional element 26 has a monolithic sheet-like structure and at least one functional portion thereof has such a thickness as to give it a resistance to penetration greater than approximately 10 N, assessed according to the ISO 20344-2004 standard related to safety shoes.

This testing method consists in providing a specimen of the material to be measured and subjecting it to penetration by a spike with a diameter of 4.50±0.05 mm, with a blunt tip with the shape and the proportions indicated.

The tip of the spike has a minimum hardness of 60 HRC.

The penetration speed of the spike is fixed at 10±3 mm/min until the tip has fully penetrated the specimen.

The maximum force value measured, expressed in newtons N, as a result of the penetration of the material, is recorded.

The test is performed on four specimens and the minimum value of the four recorded values is assigned as the value of penetration resistance of the material being tested.

The monolithic sheet-like structure is advantageously layered and cohesive, comprising a plurality of functional layers made of polymeric material that is impermeable to water in the liquid state and permeable to water vapor.

In particular, said polymeric material that is impermeable to water and permeable to water vapor is selected among microporous expanded polytetrafluoroethylene (e-PTFE) polyurethane, polyethylene, polypropylene, polyester and the like.

Furthermore, the functional portion of the functional element 26 has, in the thicknesses comprised between 0.1 mm and 3 mm, an abrasion resistance of more than 51,200 cycles, determined according to the method described in standard EN13520.

According to this standard, abrasion resistance, understood as surface resistance exhibited by a specimen of upper, lining or insole when rubbed against an abrasive fabric, is assessed by means of a Martindale machine.

A specimen of material to be examined is rubbed against a reference abrasive fabric, which is subjected to a constant pressure.

The relative motion between the abrasive fabric and the specimen is a complex cyclic motion (a Lissajous figure), which produces friction in all directions by using 16 elliptical movements (cycles) of the specimen holder.

The test is interrupted after a preset number of cycles and the damage suffered by the specimen is assessed.

The abrasive fabric has a reinforcement made of worsted-spun cloth with a minimum mass per surface unit of 195±5 g/m².

The specimen has a circular shape, with such a surface that it is contained firmly in the adapted supports, leaving exposed a circular flat portion of the surface of 645±5 mm².

The test is performed on four specimens and at the end abrasion, peeling and discoloring effects are recorded, classifying them according to one of the following descriptions: none, very slight, slight, moderate, severe, almost complete, or if a hole was made in the specimen.

Furthermore, a support 17 made of flexible sheet, on the surface of which at least one element 21 made of abrasion-resistant polymeric material is molded and comprising said functional portion of the functional element 26, again for thicknesses thereof comprised between 0.1 mm and 3 mm, has an abrasion resistance that corresponds to a loss of volume of less than 200 mm³, determined according to the method described in the EN12770 standard.

Abrasion resistance, understood as resistance to wear produced by mechanical action applied to a surface of a specimen, in accordance with the EN 12770 standard, for soles of shoes, is measured with an abrasion tester.

A specimen of material to be tested is made to slide longitudinally on a drum with a diameter of 150 mm and a length of 500 mm, which rotates at a rate of 40 RPM, on which an abrasive cloth is fixed.

The advancement of the specimen is 4.20 mm for each turn of the drum.

The abrasive cloth, covered with grade 60 aluminum oxide, has an average thickness of 1 mm and is associated uniformly with the drum.

This abrasive surface must cause a loss of mass of a standard reference rubber that is comprised between 180 mg and 220 mg on an abrasion path of 40 m.

The specimen has a cylindrical shape, with a diameter of 16 mm and a minimum height of 6 mm.

The test is performed on three specimens and the average of the measurements is assigned to the value of abrasion resistance.

For materials with a density of less than 0.9 g/cm³, the result of the abrasion test is expressed in terms of loss of relative mass in milligrams (mg), otherwise for materials with a density of more than 0.9 g/cm³ the result is expressed in terms of loss of volume in cubic millimeters (mm³), using for the calculation also the value of the volume mass (density) of the material.

As an alternative, the support 17 can be constituted by the combination of a waterproof and breathable functional element 26, which has a monolithic sheet-like structure made of polymeric material that is impermeable to water in the liquid state and permeable to water vapor, with at least one between a layer of nonwoven fabric, a layer of fabric, a layer of mesh, or a layer of leather.

For example, it can be determined by the coupling of a mesh with a functional element 26, or by the coupling of a mesh with a functional element 26 and of the latter with a protective layer made of nonwoven fabric.

It should be noted that the described method allows to obtain a support 17, comprising a waterproof and breathable functional element, which is already provided with elements 21 made of abrasion-resistant polymeric material, which can therefore be used, simply by applying it by gluing to provide a seal and by sewing accompanied by sealing, as portions of upper 24 or as tread regions 23.

The subsequent FIGS. 11, 12 and 13 show some examples of waterproof and breathable soles 31 with shoe parts 20 provided with one of the described methods and comprising, among the layers that compose them, at least one support 17 made of flexible sheet, comprising a waterproof and breathable functional element 26, on the surface of which a plurality of elements 21 made of polymeric material with abrasion resistance characteristics are molded.

FIG. 11 is a sectional view of the shoe 22, which has a waterproof and breathable sole 31, provided with a shoe part 20, the shoe 22 comprising an upper 24 (which is exemplified here in a single layer, but can be constituted conveniently by a plurality of layers, as described previously, for example comprising a lining and optionally reinforcement fabrics), which at the lower margin is folded so as to extend in the plantar region of the shoe to be joined to an insole 25, according to the manufacturing method known as AGO lasting.

As an alternative, the upper can be joined to the insole 25 by means of stitched seams according to the production method known as Strobel.

A structural layer 27 is joined to them, preferably by gluing or by direct injection into a mold, and is conveniently made of ethylen vinyl acetate (EVA), made of expanded polyurethane (PU), made of rubber or other polymeric material, which has a series of through holes 28, preferably, by way of example, with a diameter comprised approximately between 4 mm and 6 mm.

The area inside the perimetric region 29 of the structural layer 27 is covered in a downward region with a supporting layer 17 made of flexible sheet, on the surface of which a plurality of elements 21 are molded which are obtained according to one of the two embodiments of the method. In particular, the support 17 is coupled by perimetric sealing to the structural layer 27. By way of example, the width of the perimetric surface adapted for sealing is comprised preferably between 8 mm and 12 mm.

Therefore, the elements 21 distributed on the support 17 constitute a tread region 23 of the shoe 22.

The support 17 is preferably joined to the structural layer 27 also by adhesive bonding on parts inside its perimeter (to prevent it from detaching in the central region from the lower face of the structural layer 27), where the deposits of glue on the surface of the structural layer 27 are conveniently provided in regions that do not have the through holes 28.

The support 17 is of the type that comprises at least one waterproof and breathable functional element 26, of the type already described.

In particular, in the example shown, the support 17 is constituted by a waterproof and breathable functional element 26, of the type provided with a monolithic sheet-like structure, which is stratified and cohesive and comprises a plurality of functional layers made of polymeric material that is impermeable to water in the liquid state and permeable to water vapor and is not mated to supporting layers or protective layers.

It is conveniently of the type that has at least one functional portion with such a thickness as to give it a penetration resistance of more than approximately 10 N, assessed according to the method presented in chapter 5.8.2 of the ISO 20344-2004 standard.

A functional element 26 with this thickness also can be used in any case in combination with other layers so as to constitute the support 17, the outermost of which would support the elements 21. In particular, the presence of a light mesh of nylon would facilitate the grip of the elements 21 to the support 17.

Another example shown in FIG. 12 illustrates the sectional view of another shoe 22 which has a waterproof and breathable sole 31, with a shoe part 20 provided by means of one of the described methods. An insole 25 is associated with the support 17 made of flexible sheet, on the surface of which that lies opposite the one for association with the insole 25, a plurality of elements 21 made of polymeric material with abrasion resistance characteristics are molded which constitute a tread region 23 of the shoe 22. The support 17 is sewn and sealed at its edges to the edges of the upper 24 according to the method known as Strobel. In this example also, the support 17 comprises a functional element 26, again of the type that withstands penetration beyond 10 N as described previously.

The tread region 23 is defined by the area that is circumscribed by the perimetric region 29 defined by an edge 30 made of polymeric material provided by direct injection in order to mask the stitched seam of the Strobel assembly.

A third example of sole 31 with a shoe part 20 is shown in the sectional view of the shoe 22 in FIG. 13, substantially a tubular moccasin.

The upper 24 is sewn in a tubular manner and the shoe part 20 is sealed to a lower part thereof and, as in the previous examples, is constituted by a support 17 made of flexible sheet on the surface of which a plurality of elements 21 made of polymeric material with abrasion resistance characteristics are distributed, so as to constitute a tread region 23 for the sole 31, and are molded by means of one of the two versions of the method that have been described.

In this case also, the support 17 comprises a functional element 26, of the type having such a thickness so as to ensure a penetration resistance of more than approximately 10 N, being the only layer to constitute the sole and in this case also exposed to the outside.

As can be understood from these examples of parts of waterproof and breathable shoes 20, the functional element 26 can constitute the only or the last layer of the sole if it is of the type with such a thickness as to give its structure a penetration resistance of more than 10 N, assessed according to the above cited standards, being also provided with elements 21 capable of withstanding abrasion and therefore of constituting at least a part of the tread 23.

In the examples of shoe parts 20 that have been described, in which the elements 21 constitute at least one tread region 23, the support 17 can be extended to the entire sole of the shoe 22 or to portions thereof, as in FIG. 8, and the pattern that the elements 21 provide can be denser in order to protect the functional element 26 from abrasion and from external elements that might cause its tearing.

An example of thickness to be preferred for the elements 21 is comprised in the interval between 0.2 mm and 6 mm.

It should also be noted that the use of a support 17 constituted exclusively by a functional element 26, acting as a sole and optionally as an upper, reduces significantly the overall weight of the shoe 22 and increases considerably the disposal of water vapor, since it is not hindered by the presence of numerous layers.

Furthermore, the area of the sole that is assigned to the exchange of heat and the passage of water vapor is not necessarily constrained by the presence of through holes provided in a structural layer made of rubber, but in the absence of the latter coincides with the supporting surface that is free from the elements 21.

Moreover, since the functional element 26 can be applied to the outer side of the sole, the division of the structural layer 27 for interposition of the membrane, therefore of the functional element 26, is not required, simplifying the operations for providing a shoe with a thin sole and reducing in general the time to be dedicated to this type of operation.

Furthermore, advantageously, the use of a functional element 26 with a penetration resistance of more than 10 N does not require even mating with a protective layer made of felt, which by wearing would tend to become impregnated with water and mud, which would reach the functional element 26 through the holes of the tread 23, damaging it.

In practice it has been found that the invention achieves the intended aim and objects, by devising a method that can be performed with currently known technologies and with which it is possible to provide parts of shoe that are impermeable to water and permeable to water vapor, capable of ensuring an adequate exchange of heat between the microclimate inside the shoe and the outside, at the same time protecting the waterproof and breathable functional element against tears and against early wear, which would compromise its functionality.

Another advantage of the method according to the invention is that it provides supports made of flexible sheet to be applied easily to the shoe so as to constitute parts thereof that already support tread elements or protective elements or also decorative elements.

Thanks to the use of these supports, furthermore, it is possible to provide different types of shoe, with shoe parts such as the ones devised and assembled with the known AGO lasting or Strobel methods, even optionally for the production of moccasins.

A further advantage arises from the fact that by using a support that comprises at least one functional element it is not necessary to use a protective layer made of felt and therefore it is also not necessary to apply additional perimetric sealing material, which would inevitably reduce the flexibility of the sole.

The invention thus conceived is susceptible of numerous modifications and variations, all of which are within the scope of the appended claims; all the details may further be replaced with other technically equivalent elements.

In practice, the materials used, so long as they are compatible with the specific use, as well as the contingent shapes and dimensions, may be any according to requirements and to the state of the art.

The disclosures in Italian Patent Application No. PD2014A000184 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-34. (canceled)

35. A method for providing parts of waterproof and breathable shoes comprising:
preparing a mold including a first element to be closed with a second element, at least one of which includes hollow regions of a matrix of impressions and the remaining surface for mating with the other one of the elements;
opening the mold;
depositing in the hollow regions polymeric material in the fluid state with abrasion resistance characteristics;
cleaning the mating surface from any excess polymeric material by cleaning means;
positioning on at least one the mating surface a support made of flexible sheet including a waterproof and breathable functional element;
closing the mold with interposition of the support made of flexible sheet between the first element and the second element;
opening the mold after a time interval at least equal to a setting time of the polymeric material with adhesion to the support.

36. The method according to claim 35, wherein the depositing the polymeric material is followed by introduction of at least one between the first element and the second element, which includes the hollow regions, in a vacuum chamber.

37. The method according to claim 35, wherein the cleaning of the mating surface occurs by the cleaning means, which includes a doctor.

38. The method according to claim 35, wherein the first element and the second element include respectively a first mold part and a second mold part, at least one of the first and second mold parts including hollow regions of a matrix of impressions.

39. The method according to claim 35, wherein the first element includes the hollow regions of a matrix of impressions and the second element includes a plate of a press, with heated plates, for setting of the polymeric material.

40. A method for manufacturing waterproof and breathable shoe parts, comprising:
preparing a mold including a first element and a second element, which includes respectively a first mold part and a second mold part and at least one of the elements including hollow regions of a matrix of impressions fed by an injector;
opening the mold;
placing on a mating surface of the first element and the second element a support made of flexible sheet, which includes a waterproof and breathable functional element;
closing the mold with interposition of the support made of flexible sheet between the first element and the second element;
injecting a polymeric material in a fluid state with abrasion resistance characteristics in the matrix of impressions by the injector;
opening the mold after a time interval equal at least to a setting time of the polymeric material with adhesion to the support.

41. The method according to claim 40, wherein the hollow regions of the matrix of impressions are mutually connected by injection channels.

42. The method according to claim 40, wherein each hollow region of the matrix of impressions is fed by an injection channel.

43. A part of a waterproof and breathable shoe, manufactured with a method according to claim 35, comprising the support made of flexible sheet on a surface of which at least one element made of polymeric material with abrasion resistance characteristics is molded.

44. The shoe part according to claim 43, wherein a plurality of the elements is distributed on the surface of the support made of flexible sheet.

45. The shoe part according to claim 44, wherein the elements distributed on the support constitute at least one tread region of a shoe.

46. The shoe part according to claim 43, wherein the support constitutes at least one portion of an upper of the shoe, on which at least one of the elements is molded to constitute a reinforcement part.

47. The shoe part according to claim 43, wherein the support constitutes at least one portion of an upper of the shoe, on which at least one of the elements is molded to constitute a decorative element for the shoe.

48. The shoe part according to claim 43, wherein the support made of flexible sheet comprises a waterproof and breathable functional element made of polymeric material that is impermeable to water in the liquid state and permeable to water vapor.

49. The shoe part according to claim 48, wherein the functional element has a monolithic sheet-like structure made of polymeric material that is impermeable to water in the liquid state and permeable to water vapor.

50. The shoe part according to claim 49, wherein at least one functional portion of the functional element has such a thickness to give a penetration resistance of more than approximately 10 N, assessed according to the method described in chapter 5.8.2 of the ISO 20344-2004 standard.

51. The shoe part according to claim 50, wherein the monolithic sheet-like structure is stratified and cohesive, including a plurality of functional layers made of polymeric material that is impermeable to water in the liquid state and permeable to water vapor.

52. The shoe part according to claim 48, wherein the polymeric material that is impermeable to water in the liquid state and permeable to water vapor is microporous expanded polytetrafluoroethylene (e-PTFE).

53. The shoe part according to claim 48, wherein the polymeric material that is impermeable to water in the liquid state and permeable to water vapor is selected among polyurethane, polyethylene, polypropylene, and polyester.

54. The shoe part according to claim 50, wherein the functional portion of the functional element has, in thicknesses between 0.1 mm and 3 mm, an abrasion resistance of more than 51200 cycles, determined according to the method described in the EN13520 standard.

55. The shoe part according to claim 50, wherein the support made of flexible sheet, on a surface of which at least one element made of polymeric material with abrasion resistance characteristics and including the functional portion of the functional element is molded, has, for thicknesses of the functional portion comprised between 0.1 mm and 3 mm, an abrasion resistance that corresponds to a loss of volume of less than 200 mm3, determined according to the method described in the EN12770 standard.

56. The shoe part according to claim 43, wherein the support made of flexible sheet includes a layer of non-woven fabric.

57. The shoe part according to claim 43, wherein the support made of flexible sheet includes a layer of fabric.

58. The shoe part according to claim 43, wherein the support made of flexible sheet includes a layer of mesh.

59. The shoe part according to claim 43, wherein the support made of flexible sheet includes a layer made of leather.

60. The shoe part according to claim 58, wherein the support made of flexible sheet is formed by coupling of the mesh with a functional element.

61. The shoe part according to claim 58, wherein the support made of flexible sheet is formed by coupling of the mesh with a functional element and of the functional element with a protective layer made of non-woven fabric.

62. A part of a waterproof and breathable shoe, manufactured with a method according to claim 40, comprising the support made of flexible sheet on the surface of which at least one element made of polymeric material with abrasion resistance characteristics is molded.

63. A waterproof and breathable sole, with a shoe part manufactured by a method according to claim 35, comprising the support made of flexible sheet, which comprises a waterproof and breathable functional element, on a surface of which at least one element made of polymeric material with abrasion resistance characteristics is molded.

64. The waterproof and breathable sole according to claim 63, further comprising a structural layer made of polymeric material which has a series of through holes, to which the support made of flexible material is coupled by perimetric sealing.

65. A waterproof and breathable sole, with a shoe part manufactured by a method according to claim 40, comprising the support made of flexible sheet, which comprises a waterproof and breathable functional element, on a surface of which at least one element made of polymeric material with abrasion resistance characteristics is molded.

66. The waterproof and breathable sole with a shoe part manufactured with a method according to claim 35, comprising an insole associated with the support made of flexible sheet, on a surface of which at least one element made of polymeric material with abrasion resistance characteristics is molded.

67. The waterproof and breathable sole with a shoe part manufactured with a method according to claim 40, comprising an insole associated with the support made of flexible sheet, on a surface of which at least one element made of polymeric material with abrasion resistance characteristics is molded.

68. The waterproof and breathable sole of a tubular shoe with a shoe part manufactured with a method according to claim 35, wherein the shoe part is sealed to a lower part of the upper and comprises a support made of flexible sheet on a surface of which at least one element made of polymeric material with abrasion resistance characteristics is molded to constitute at least one tread region for the sole.

69. The waterproof and breathable sole of a tubular shoe with a shoe part manufactured with a method according to claim 40, wherein the shoe part is sealed to a lower part of the upper and comprises a support made of flexible sheet on a surface of which at least one element made of polymeric material with abrasion resistance characteristics is molded so as to constitute at least one tread region for the sole.

70. The shoe part according to claim 43, wherein the polymeric material of the at least one element covers substantially 10% of the surface of the support.

71. The shoe part according to claim 43, wherein the polymeric material of the at least one element covers a percentage of the surface of the support that is comprised substantially between 10% and 20%.

72. The shoe part according to claim 43, wherein the polymeric material of the at least one element coves a percentage of the surface of the support that is substantially between 10% and 30%.
